(19) United States
(12) Patent Application Publication
(10) Pub. No.: US 2025/0244079 A1
(43) Pub. Date: Jul. 31, 2025

(54) FLUIDIZED FURNACE DISTRIBUTION PLATE AND FLUIDIZED FURNACE INCLUDING THE SAME

(71) Applicant: POSCO Co., Ltd, Pohang-si, Gyeongsangbuk-do (KR)

(72) Inventors: Myoung Gyun SHIN, Pohang-si, Gyeongsangbuk-do (KR); Sanghyun Kim, Pohang-si, Gyeongsangbuk-do (KR); Dongwon KIM, Pohang-si, Gyeongsangbuk-do (KR); Kwangmin KIM, Pohang-si, Gyeongsangbuk-do (KR); Chang Kuk KO, Pohang-si, Gyeongsangbuk-do (KR)

(73) Assignee: POSCO Co., Ltd, Pohang-si, Gyeongsangbuk-do (KR)

(21) Appl. No.: 18/700,113

(22) PCT Filed: Sep. 4, 2023
(86) PCT No.: PCT/KR2023/013195

§ 371 Date: Apr. 10, 2024

(51) Int. Cl. F27B 15/10; F23C 10/20; F27D 1/00

(52) U.S. Cl. CPC F27B 15/10; F23C 10/20; F27D 1/0043; F27D 2001/0069

(57) ABSTRACT

Disclosed is a fluidized furnace distribution plate positioned in a fluidized furnace configured to reduce powdered ore, the fluidized furnace distribution plate including a plurality of support beams supported on an inner wall of the fluidized furnace while traversing an interior of the fluidized furnace, and a plurality of grid plates welded to the plurality of support beams and configured to define a single distribution plate shape.

### TECHNICAL FIELD

The present disclosure relates to a fluidized furnace distribution plate and a fluidized furnace including the same.

### BACKGROUND ART

In general, a direct iron ore smelting reduction process facility, which manufactures molten iron by directly using powdered ore includes a plurality of fluidized furnaces for performing fluidized reduction processing on the powdered ore.

The fluidized furnace reduces powdered ore, which is iron ore in the form of powder, to reduced iron by using high-temperature reducing gas supplied from a gasification melting furnace.

The fluidized furnace in the related art includes therein a fluidized furnace distribution plate on which a plurality of nozzles, through which the reducing gas passes, is supported. The fluidized furnace distribution plate in the related art includes a refractory material configured to traverse the interior of the fluidized furnace, a guide pipe configured to penetrate the refractory material, and the plurality of nozzles installed on the guide pipe. The high-temperature reducing gas passes through the nozzles of the fluidized furnace distribution plate and fluidizes the powdered ore loaded into the fluidized furnace from above, thereby reducing the powdered ore to reduced iron powder.

However, the fluidized furnace distribution plate in the related art has a problem in that adhesive dust contained in the reducing gas is attached to inner surfaces of the nozzles, outlets of the nozzles are narrowed or clogged, and the plurality of nozzles needs to be regularly cleaned or replaced over a long period of time.

In addition, the fluidized furnace distribution plate in the related art has a problem in that columns for supporting the refractory material are installed between the fluidized furnace distribution plate and the bottom of the fluidized furnace to support the weight of the refractory material, which decreases a flow rate of the reducing gas to be supplied to a lower side of the fluidized furnace. In addition, the fluidized furnace distribution plate in the related art has a problem in that in case that the refractory material, which supports the plurality of nozzles, is damaged, an overall function of the distribution plate is degraded because it is difficult to repair the refractory material.

### DISCLOSURE

### Technical Problem

The present disclosure attempts to provide a fluidized furnace distribution plate that is light in weight, is easy to partially replace, and has a plurality of nozzles that need not be subjected to maintenance, which may improve maintenance efficiency, minimize maintenance time, and improve a fluidized furnace operation rate and fluidized furnace efficiency, and a fluidized furnace including the same.

### Technical Solution

One aspect provides a fluidized furnace distribution plate positioned in a fluidized furnace configured to reduce powdered ore, the fluidized furnace distribution plate including: a plurality of support beams supported on an inner wall of the fluidized furnace while traversing an interior of the fluidized furnace; and a plurality of grid plates welded to the plurality of support beams and configured to define a single distribution plate shape.

The plurality of support beams may include: a plurality of first beams spaced apart from one another in one direction and supported on the inner wall of the fluidized furnace; and a plurality of second beams configured to connect the plurality of first beams in one direction.

The plurality of first beams may include H-shaped beams.

The plurality of first beams may have a larger thickness than the plurality of second beams.

The plurality of grid plates may include: a plurality of outer plates disposed along the inner wall of the fluidized furnace and disposed outside the single distribution plate; and a plurality of inner plates disposed adjacent to the plurality of outer plates and disposed inside the single distribution plate.

The plurality of inner plates may have the same shape.

The plurality of outer plates may be different in shape from the inner plates.

The plurality of outer plates may include a plurality of first nozzle holes, and the plurality of inner plates may include a plurality of second nozzle holes different in shape from the plurality of first nozzle holes.

The plurality of first nozzle holes may have a shape inclined with respect to a vertical direction.

The plurality of second nozzle holes may have a triangular shape with respect to a vertical direction.

The adjacent grid plates, among the plurality of grid plates, may be spaced apart from each other on the support beams.

The fluidized furnace distribution plate may further include: a plurality of brackets disposed in a circumferential direction of the inner wall of the fluidized furnace and fixed to the inner wall of the fluidized furnace.

The plurality of support beams may be fixed to the plurality of brackets.

The fluidized furnace distribution plate may further include: an upper support ring configured to connect upper portions of the plurality of brackets in the circumferential direction of the inner wall of the fluidized furnace.

The fluidized furnace distribution plate may further include: a lower support ring spaced apart from the upper support ring with the plurality of brackets interposed therebetween, the lower support ring being configured to connect lower portions of the plurality of brackets in the circumferential direction of the inner wall of the fluidized furnace.

A first refractory material may be positioned on an upper portion of the upper support ring, a second refractory material may be positioned on a lower portion of the lower support ring, and the upper support ring, the plurality of brackets, and the lower support ring may be positioned between the first refractory material and the second refractory material.

The fluidized furnace distribution plate may further include: ceramic ropes positioned between the upper support ring and the first refractory material and between the lower support ring and the second refractory material.

The plurality of grid plates may include stainless steel.

In addition, another aspect provides a fluidized furnace including: a fluidized furnace main body configured to reduce powdered ore; and a fluidized furnace distribution plate positioned inside the fluidized furnace main body, in which the fluidized furnace distribution plate includes: a plurality of support beams supported on an inner wall of the fluidized furnace main body while traversing an interior of the fluidized furnace main body; and a plurality of grid plates welded to the plurality of support beams and configured to define a single distribution plate shape.

The plurality of grid plates may include stainless steel.

### Advantageous Effect

The embodiment provides the fluidized furnace distribution plate that is light in weight, is easy to partially replace, and has the plurality of nozzles that need not be subjected to maintenance, which may improve maintenance efficiency, minimize maintenance time, and improve the fluidized furnace operation rate and fluidized furnace efficiency, and the fluidized furnace including the same.

### DESCRIPTION OF THE DRAWINGS

FIG. 1 is a perspective view illustrating a state in which a fluidized furnace according to an embodiment is cut out in a vertical direction.

FIG. 2 is a longitudinal sectional view illustrating part A in FIG. 1.

FIG. 3 is a perspective view illustrating a lower side of a fluidized furnace distribution plate included in the fluidized furnace according to the embodiment.

FIG. 4 is a top plan view illustrating an upper side of the fluidized furnace distribution plate included in the fluidized furnace according to the embodiment.

### MODE FOR INVENTION

Hereinafter, embodiments of the present disclosure will be described in detail with reference to the accompanying drawings so that those with ordinary skill in the art to which the present disclosure pertains may easily carry out the embodiments. The present disclosure may be implemented in various different ways, and is not limited to the embodiments described herein.

A part irrelevant to the description will be omitted to clearly describe the present disclosure, and the same or similar constituent elements will be designated by the same reference numerals throughout the specification.

Throughout the specification, unless explicitly described to the contrary, the word “comprise/include” and variations such as “comprises/includes” or “comprising/including” will be understood to imply the inclusion of stated elements, not the exclusion of any other elements.

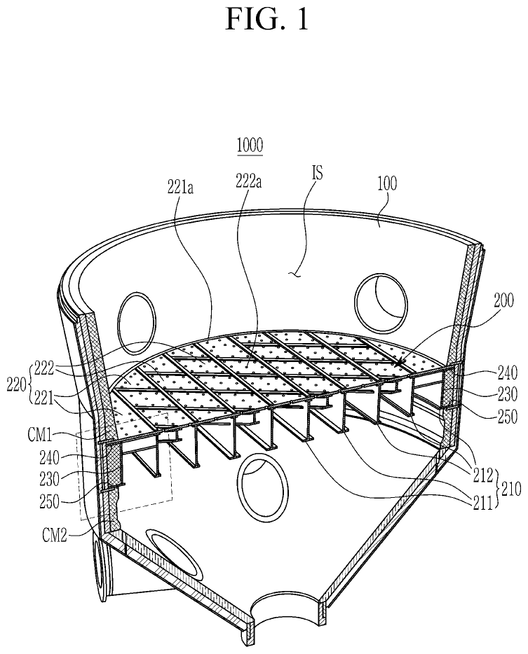

Hereinafter, a fluidized furnace according to an embodiment will be described with reference to FIGS. 1 to 4.

The fluidized furnace according to the embodiment may be one of the plurality of fluidized furnaces included in a direct iron ore smelting reduction process facility that reduces powdered ore, which is iron ore in the form of powder, to reduced iron. However, the present disclosure is not limited thereto. For example, the direct iron ore smelting reduction process facility may include the plurality of fluidized furnaces configured to reduce powdered ore to reduced iron powder, a publicly-known agglomeration device configured to manufacture agglomerates by compressing reduced iron powder, and a publicly-known gasification melting furnace. The powdered ore is loaded into the fluidized furnaces, and reduced iron powder manufactured by the fluidized furnaces is used to manufacture the agglomerates by the agglomeration device. The agglomerates, together with coal briquette, are supplied to the gasification melting furnace, such that molten iron may be manufactured. A reducing gas generated from the gasification melting furnace may be supplied to the fluidized furnaces.

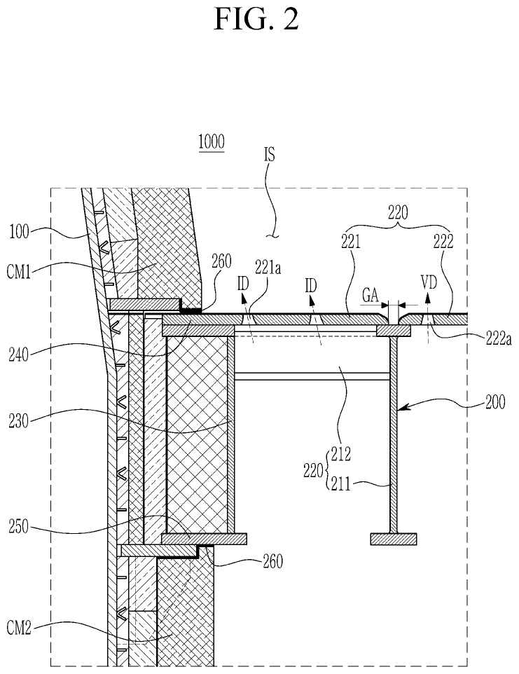

FIG. 1 is a perspective view illustrating a state in which a fluidized furnace according to an embodiment is cut out in a vertical direction. The fluidized furnace illustrated in FIG. 1, which is a view illustrating a lower side of the fluidized furnace at which a fluidized furnace distribution plate is positioned, may have various publicly-known overall shapes. FIG. 2 is a longitudinal sectional view illustrating part A in FIG. 1.

With reference to FIGS. 1 and 2, a fluidized furnace 1000 includes a fluidized furnace main body 100 and a fluidized furnace distribution plate 200.

The fluidized furnace main body 100 defines an internal space IS in which powdered ore is reduced. The fluidized furnace main body 100 has a cylindrical shape, but the present disclosure is not limited thereto. The fluidized furnace main body 100 may have various publicly-known shapes. The fluidized furnace distribution plate 200 is positioned at a lower side of the internal space IS of the fluidized furnace main body 100. Based on the fluidized furnace distribution plate 200, the powdered ore is loaded into an upper side of the fluidized furnace main body 100, and the reducing gas is supplied to a lower side of the fluidized furnace main body 100. The reducing gas supplied to the lower side of the fluidized furnace main body 100 is distributed and sprayed to the powdered ore positioned above the fluidized furnace distribution plate 200, and a fluidized bed may be formed above the fluidized furnace distribution plate 200.

The fluidized furnace distribution plate 200 distributes the reducing gas, which is supplied to the lower side of the fluidized furnace distribution plate 200, to the powdered ore positioned above the fluidized furnace distribution plate 200. The fluidized furnace distribution plate 200 includes a plurality of support beams 210, a plurality of grid plates 220, a plurality of brackets 230, an upper support ring 240, a lower support ring 250, and ceramic ropes 260.

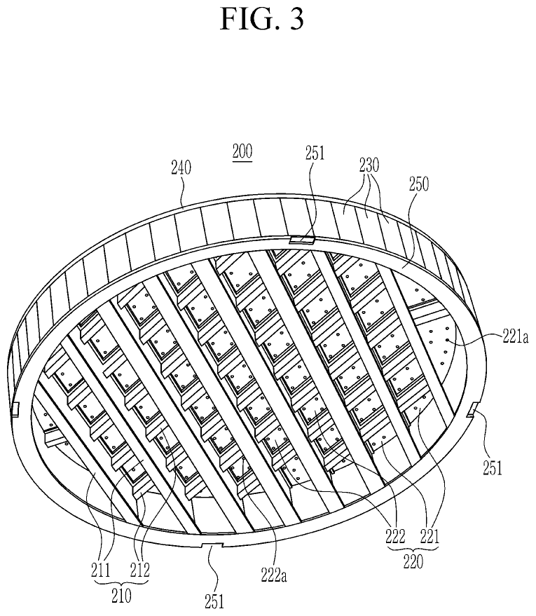

FIG. 3 is a perspective view illustrating the lower side of the fluidized furnace distribution plate included in the fluidized furnace according to the embodiment.

With reference to FIGS. 3, 1, and 2, the plurality of support beams 210 is supported on an inner wall of the fluidized furnace 1000 while traversing the interior of the fluidized furnace 1000 that is the internal space IS defined by the fluidized furnace main body 100. The plurality of support beams 210 may be fixed to the plurality of brackets 230 and supported on the inner wall of the fluidized furnace 1000. However, the present disclosure is not limited thereto. The plurality of support beams 210 may be fixed to the inner wall of the fluidized furnace 1000 by using various support means.

The plurality of support beams 210 includes a plurality of first beams 211 and a plurality of second beams 212.

The plurality of first beams 211 is spaced apart from one another in one direction and supported on the inner wall of the fluidized furnace 1000. In this case, one direction may be a diameter direction that traverses a circumference defined by the inner wall of the fluidized furnace 1000. However, the present disclosure is not limited thereto. The plurality of first beams 211 includes H-shaped beams. However, the present disclosure is not limited thereto. The plurality of first beams 211 has a larger thickness than the plurality of second beams 212. In this case, a thickness of the first beam 211 may include a length of the first beam 211 in the vertical direction. The plurality of first beams 211 may be eight H-shaped beams with a thickness of 1,000 mm. However, the present disclosure is not limited thereto.

The plurality of second beams 212 connects the plurality of first beams 211 in one direction, i.e., the direction in which the plurality of first beams 211 is spaced apart from one another. The plurality of second beams 212 includes H-shaped beams. However, the present disclosure is not limited thereto. The plurality of second beams 212 has a smaller thickness than the plurality of first beams 211. In this case, a thickness of the second beam 212 may include a length of the second beam 212 in the vertical direction. The plurality of second beams 212 may be 42 H-shaped beams with a thickness of 300 mm. However, the present disclosure is not limited thereto.

The plurality of grid plates 220 is welded to surfaces of the H-shaped beams included in the plurality of first beams 211 and the plurality of second beams 212.

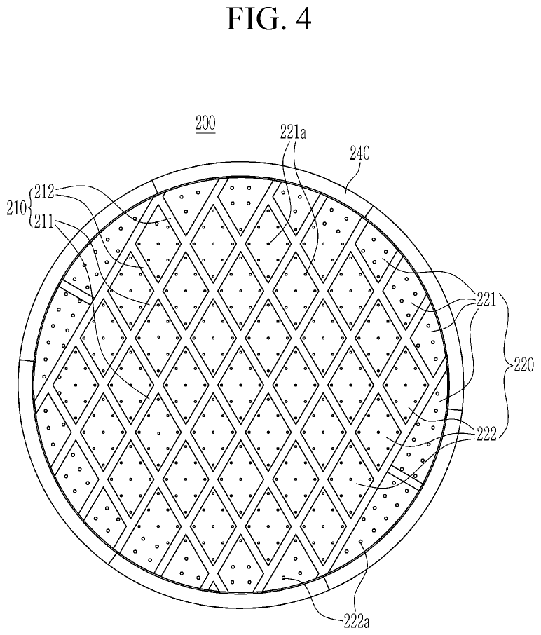

FIG. 4 is a top plan view illustrating the upper side of the fluidized furnace distribution plate included in the fluidized furnace according to the embodiment. With reference to FIGS. 4, 1, and 2, the plurality of grid plates 220 is welded to the plurality of support beams 210 and constitutes a single distribution plate shape. The plurality of grid plates 220 includes a plurality of outer plates 221 disposed outside the single distribution plate shape and disposed along the circumference defined by the inner wall of the fluidized furnace 1000, and a plurality of inner plates 222 positioned inside the plurality of outer plates 221.

The plurality of outer plates 221 is disposed along the inner wall of the fluidized furnace 1000 and disposed outside the single distribution plate configured by the plurality of grid plates 220. The plurality of outer plates 221 is different in shape from the inner plates 222. The plurality of outer plates 221 may have different shapes corresponding to the circumference defined by the inner wall of the fluidized furnace 1000. However, the present disclosure is not limited thereto. The plurality of outer plates 221 includes a plurality of first nozzle holes 221a through which the reducing gas passes. The plurality of first nozzle holes 221a is different in shape from a plurality of second nozzle holes 222a included in the plurality of inner plates 222. The plurality of first nozzle holes 221a is inclined in an inclination direction ID with respect to a vertical direction VD directed toward the plurality of second nozzle holes 222a so that the plurality of first nozzle holes 221a is directed toward the inner wall of the fluidized furnace 1000. The plurality of first nozzle holes 221a may be 112 first nozzle holes, but the present disclosure is not limited thereto.

The plurality of inner plates 222 is disposed adjacent to the plurality of outer plates 221 and disposed inside the single distribution plate configured by the plurality of grid plates 220. The plurality of inner plates 222 has the same rhombic shape, but the present disclosure is not limited thereto. The plurality of inner plates 222 includes the plurality of second nozzle holes 222a through which the reducing gas passes. The plurality of second nozzle holes 222a is different in shape from the plurality of first nozzle holes 221a included in the plurality of outer plates 221. The plurality of second nozzle holes 222a is directed toward the vertical direction VD and has a triangular shape based on the vertical direction VD. The plurality of second nozzle holes 222a may be 331 second nozzle holes spaced apart from one another with a pitch of 350 mm. However, the present disclosure is not limited thereto.

The plurality of first nozzle holes 221a is inclined in the inclination direction ID so as to be directed toward the inner wall of the fluidized furnace 1000. Because the plurality of second nozzle holes 222a is directed in the vertical direction VD, the reducing gas, which passes through the plurality of first nozzle holes 221a and the plurality of second nozzle holes 222a, is distributed to a wider area from an upper side of the fluidized furnace distribution plate 200.

Among the plurality of grid plates 220 including the plurality of outer plates 221 and the plurality of inner plates 222, the adjacent grid plates 220 are spaced apart from each other at a preset interval GA and disposed on the support beams 210.

The plurality of grid plates 220 includes stainless steel. For example, the plurality of grid plates 220 includes stainless steel with SUS304H standard. However, the present disclosure is not limited thereto. The plurality of grid plates 220 may include stainless steel with SUS316, SUS310S, SUS321, and 800H standards.

The plurality of grid plates 220 includes stainless steel, but the adjacent grid plates 220, among the plurality of grid plates 220, are disposed on the support beams 210 and spaced apart from each other at the preset interval GA, which suppresses interference between the plurality of grid plates 220 caused by thermal expansion.

The plurality of grid plates 220 may be 62 grid plates, but the present disclosure is not limited thereto.

In addition, the plurality of support beams 210, the plurality of brackets 230, the upper support ring 240, and the lower support ring 250 include stainless steel with SUS304H standard. However, the present disclosure is not limited thereto. The plurality of support beams 210, the plurality of brackets 230, the upper support ring 240, and the lower support ring 250 may include stainless steel with SUS316, SUS310S, SUS321, and 800H standards.

With reference to FIGS. 1 to 3, the plurality of brackets 230 is fixed to the inner wall of the fluidized furnace 1000 in a circumferential direction of the inner wall of the fluidized furnace 1000. The plurality of brackets 230 is fixed to the inner wall of the fluidized furnace 1000 while defining a rim of the fluidized furnace distribution plate 200. The plurality of support beams 210 may be fixed to the plurality of brackets 230, and the plurality of support beams 210 may be welded and fixed to the plurality of brackets 230. The plurality of brackets 230 may include 100 brackets 230, but the present disclosure is not limited thereto.

The upper support ring 240 connects upper portions of the plurality of brackets 230 in the circumferential direction of the inner wall of the fluidized furnace 1000. The upper support ring 240 may be fixed to the upper portions of the plurality of brackets 230 by welding. However, the present disclosure is not limited thereto. The plurality of brackets 230 may be fixed by being fitted between the upper support ring 240 and the lower support ring 250.

The lower support ring 250 is spaced apart from the upper support ring 240 with the plurality of brackets 230 interposed therebetween. The lower support ring 250 connects lower portions of the plurality of brackets 230 in the circumferential direction of the inner wall of the fluidized furnace 1000. The lower support ring 250 may be fixed to the lower portions of the plurality of brackets 230 by welding. However, the present disclosure is not limited thereto. The plurality of brackets 230 may be fixed by being fitted between the lower support ring 250 and the upper support ring 240.

For example, with reference to FIG. 3, four support grooves 251 spaced apart from one another may be formed in a lower portion of the lower support ring 250. The four support grooves 251 may be fixed by being fitted with four protruding portions that may be formed on the inner wall of the fluidized furnace 1000.

Various publicly-known first refractory materials CM1 may be positioned on an upper portion of the upper support ring 240, and various publicly-known second refractory materials CM2 may be positioned on the lower portion of the lower support ring 250. The upper support ring 240, the plurality of brackets 230, and the lower support ring 250, which define the rim of the fluidized furnace distribution plate 200, may be positioned between the first refractory materials CM1 and the second refractory materials CM2.

With reference to FIG. 2, the ceramic ropes 260 are positioned between the upper support ring 240 and the first refractory material CM1 and between the lower support ring 250 and the second refractory material CM2. When the upper support ring 240 and the lower support ring 250 are thermally expanded, the ceramic ropes 260 are respectively compressed against the first refractory material CM1 and the second refractory material CM2, such that the portion between the fluidized furnace distribution plate 200 and the inner wall of the fluidized furnace 1000 may be sealed.

As described above, the fluidized furnace distribution plate 200 included in the fluidized furnace 1000 according to the embodiment includes the plurality of support beams 210 and the plurality of grid plates 220 welded to the plurality of support beams 210 and configured to constitute the single distribution plate shape. Therefore, in case that adhesive dust contained in the reducing gas is attached to the plurality of grid plates 220 or some of the plurality of grid plates 220 are damaged, the surfaces of the plurality of grid plates 220 may be cleaned, or only some of the plurality of grid plates 220, which are damaged, may be replaced with new grid plates 220. Therefore, it is possible to improve the efficiency in maintaining the fluidized furnace distribution plate 200 and minimize the maintenance time.

In addition, according to the fluidized furnace distribution plate 200 included in the fluidized furnace 1000 according to the embodiment, the plurality of grid plates 220 is lighter in weight than the refractory material in the related art. Therefore, it is not necessary to install columns between the fluidized furnace distribution plate 200 and the bottom of the fluidized furnace 1000 to support the weights of the plurality of grid plates 220. Therefore, it is possible to suppress the deterioration in flow rate of the reducing gas to be supplied to the lower side of the fluidized furnace 1000.

That is, it is possible to provide the fluidized furnace distribution plate 200 that is light in weight, is easy to partially replace, and has the plurality of nozzles that need not be subjected to maintenance, which may improve maintenance efficiency, minimize maintenance time, and improve the fluidized furnace operation rate and fluidized furnace efficiency, and the fluidized furnace 1000 including the same.

Although the embodiments of the present disclosure have been described in detail above, the right scope of the present disclosure is not limited thereto, and it should be construed that many variations and modifications made by those skilled in the art using the basic concept of the present disclosure, which is defined in the following claims, will also belong to the right scope of the present disclosure.

### DESCRIPTION OF REFERENCE NUMERALS

Fluidized furnace 1000, Fluidized furnace distribution plate 200, Support beam 210, Grid plate 220

1. A fluidized furnace distribution plate comprising:
A fluidized furnace distribution plate positioned in a fluidized furnace configured to reduce powdered ore, the fluidized furnace distribution plate comprising:
a plurality of support beams supported on an inner wall of the fluidized furnace while traversing an interior of the fluidized furnace; and
a plurality of grid plates welded to the plurality of support beams and configured to define a single distribution plate shape.

2. The fluidized furnace distribution plate of claim 1, wherein:
the plurality of support beams comprises:
a plurality of first beams spaced apart from one another in one direction and supported on the inner wall of the fluidized furnace; and
a plurality of second beams configured to connect the plurality of first beams in one direction.

3. The fluidized furnace distribution plate of claim 2, wherein:
the plurality of first beams includes H-shaped beams.

4. The fluidized furnace distribution plate of claim 2, wherein:
the plurality of first beams has a larger thickness than the plurality of second beams.

5. The fluidized furnace distribution plate of claim 1, wherein:
the plurality of grid plates comprises:
a plurality of outer plates disposed along the inner wall of the fluidized furnace and disposed outside the single distribution plate; and
a plurality of inner plates disposed adjacent to the plurality of outer plates and disposed inside the single distribution plate.

6. The fluidized furnace distribution plate of claim 5, wherein:
the plurality of inner plates has the same shape.

7. The fluidized furnace distribution plate of claim 6, wherein:
the plurality of outer plates is different in shape from the inner plates.

8. The fluidized furnace distribution plate of claim 5, wherein:
the plurality of outer plates comprises a plurality of first nozzle holes, and
the plurality of inner plates comprises a plurality of second nozzle holes different in shape from the plurality of first nozzle holes.

9. The fluidized furnace distribution plate of claim 8, wherein:
the plurality of first nozzle holes has a shape inclined with respect to a vertical direction.

10. The fluidized furnace distribution plate of claim 8, wherein:
the plurality of second nozzle holes has a triangular shape with respect to a vertical direction.

11. The fluidized furnace distribution plate of claim 1, wherein:
the adjacent grid plates, among the plurality of grid plates, are spaced apart from each other on the support beams.

12. The fluidized furnace distribution plate of claim 1, further comprising:
a plurality of brackets disposed in a circumferential direction of the inner wall of the fluidized furnace and fixed to the inner wall of the fluidized furnace.

13. The fluidized furnace distribution plate of claim 12, wherein:
the plurality of support beams is fixed to the plurality of brackets.

14. The fluidized furnace distribution plate of claim 12, further comprising:
an upper support ring configured to connect upper portions of the plurality of brackets in the circumferential direction of the inner wall of the fluidized furnace.

15. The fluidized furnace distribution plate of claim 14, further comprising:
a lower support ring spaced apart from the upper support ring with the plurality of brackets interposed therebetween, the lower support ring being configured to connect lower portions of the plurality of brackets in the circumferential direction of the inner wall of the fluidized furnace.

16. The fluidized furnace distribution plate of claim 15, wherein:
a first refractory material is positioned on an upper portion of the upper support ring,
a second refractory material is positioned on a lower portion of the lower support ring, and
the upper support ring, the plurality of brackets, and the lower support ring are positioned between the first refractory material and the second refractory material.

17. The fluidized furnace distribution plate of claim 16, further comprising:
ceramic ropes positioned between the upper support ring and the first refractory material and between the lower support ring and the second refractory material.

18. The fluidized furnace distribution plate of claim 1, wherein:
the plurality of grid plates includes stainless steel.

19. A fluidized furnace comprising:
a fluidized furnace main body configured to reduce powdered ore; and
a fluidized furnace distribution plate positioned inside the fluidized furnace main body,
wherein the fluidized furnace distribution plate comprises:
a plurality of support beams supported on an inner wall of the fluidized furnace main body while traversing an interior of the fluidized furnace main body; and
a plurality of grid plates welded to the plurality of support beams and configured to define a single distribution plate shape.

20. The fluidized furnace of claim 19, wherein:
the plurality of grid plates includes stainless steel.
